(19) United States
(12) Patent Application Publication
(10) Pub. No.: US 2019/0363393 A1
(43) Pub. Date: Nov. 28, 2019

(54) SYSTEM AND METHOD OF ASSEMBLING A BATTERY CELL STACK

(71) Applicant: Fives Cinetic Corp., Farmington Hills, MI (US)

(72) Inventors: Amjad Qusay Hashem, Dearborn Heights, MI (US); Gary T. McKeogh, Holly, MI (US); Jason A. Glinz, Brighton, MI (US)

(73) Assignee: Fives Cinetic Corp., Farmington Hills, MI (US)

(21) Appl. No.: 16/413,067

(22) Filed: May 15, 2019

Related U.S. Application Data
(60) Provisional application No. 62/675,259, filed on May 23, 2018.

(51) Int. Cl. H01M 10/04; H01M 2/10

(52) U.S. Cl. CPC H01M 10/0486; H01M 2/1016

(57) ABSTRACT

A method of assembling a battery cell stack includes providing a plurality of cell handling stations disposed around a transport system. The transport system is operable to move each of the stack locations past each of the plurality of cell handling stations once during a transport cycle. The plurality of cell handling stations includes a number of group preparation stations. One of a plurality of battery cells of one of a plurality of cell groups is positioned on each respective stack location with each respective group preparation station during each transport cycle. The transport system is moved through a pre-defined number of transport cycles.

### CROSS-REFERENCE TO RELATED APPLICATIONS

This application claims the benefit of and priority to U.S. Provisional Patent Application 62/675,259, which was filed on May 23, 2018, and which is incorporated by reference in its entirety.

### TECHNICAL FIELD

The disclosure generally relates to a method and system for assembling a battery cell stack.

### BACKGROUND

Multiple battery cells may be interconnected and arranged to form a battery cell stack, with multiple such battery cell stacks being interconnected to form a battery pack. The individual battery cells may be electrically connected in series and/or in parallel to deliver an application-specific voltage, current, or power density. Battery packs may include a discrete number of battery cell configurations in which each of the respective battery cells are differently configured. The battery cell configurations may vary in the cell's orientation, i.e., the position of the positive and negative terminals of the battery cell relative to the battery cell stack, a length or shape of the positive and/or negative terminal, the presence of an isolation layer, etc. The different battery cell configurations may be arranged in a defined sequence to form a cell group. The battery pack may include several such cell groups. Because the cell groups are repeated, the battery pack may use multiple numbers of the same or similar battery cell configurations.

### SUMMARY

A method is disclosed herein for assembling a battery cell stack. The battery cell stack includes multiple cell groups, with each respective one of which has multiple battery cells arranged in a defined sequence. Cell handling stations are disposed around a transport system having a number of stack locations that in some embodiments is equal to a total number of the cell handling stations. The transport system is operable for moving each stack location past each of the cell handling stations, doing so once per transport cycle. The cell handling stations includes a number of group preparation stations. One of the battery cells of a given one of the cell groups is positioned on each respective stack location of each respective group preparation station during the respective transport cycles. Optionally, one cell group may be formed per transport cycle. The transport system is moved through a pre-defined number of such transport cycles, with the pre-defined number of transport cycles being equal to the total number of cell groups.

An assembly line for assembling the battery cell stack is also disclosed. The battery stack includes multiple cell groups, each respective one of which has corresponding battery cells arranged in a defined sequence as noted above. The assembly line includes a transport system having a number of stack locations and a conveyor. The conveyor is operable for moving the stack locations in a closed loop. Cell handling stations are positioned around the transport system, with a number of stack locations being equal to the total number of cell handling stations.

The conveyor moves each stack location past each of the cell handling stations, doing so once during a given transport cycle of the closed loop. The cell handling stations include a number of group preparation stations that is equal to a total number of battery cells within each cell group. Each respective group preparation station is dedicated to preparing one respective battery cell within the defined sequence of battery cells for each cell group.

Accordingly, one cell group is formed in the battery cell stack for each transport cycle. As noted above, the assembly line rotates the stack locations past the group preparation stations using the pre-defined number of transport cycles to form all of the cell groups. An overall assembly time for the battery cell stack may be reduced by assembling the battery cell stack in the disclosed manner relative to traditional linear assembly line processes.

The cell handling stations may further include a stack unloading station operable for removing a completed battery cell stack from the transport system, and additional non-group handling stations configured to position the end plates and any non-group battery cells that are not included in the multiple cell groups.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic plan view illustration of an assembly line for assembling a battery cell stack.

FIG. 2 is a schematic exploded cross-sectional side view of an exemplary embodiment of the battery cell stack.

FIG. 3 is a schematic plan view of a cell preparation station of the assembly line according to an embodiment.

The present disclosure is susceptible to modifications and alternative forms, with representative embodiments shown by way of example in the drawings and described in detail below. Inventive aspects of this disclosure are not limited to the disclosed embodiments. Rather, the present disclosure is intended to cover modifications, equivalents, combinations, and alternatives falling within the scope of the disclosure as defined by the appended claims.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

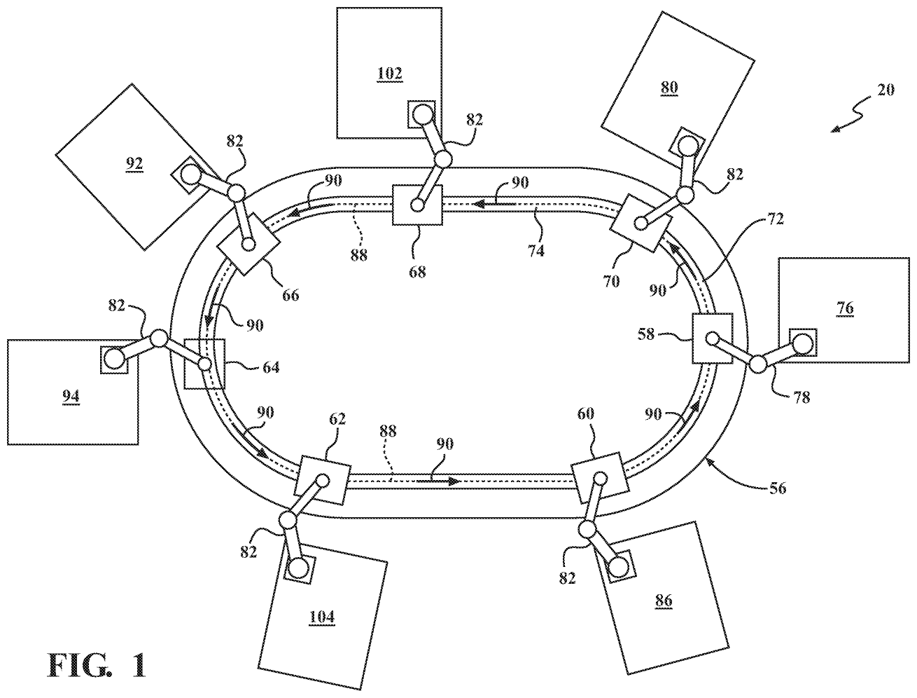

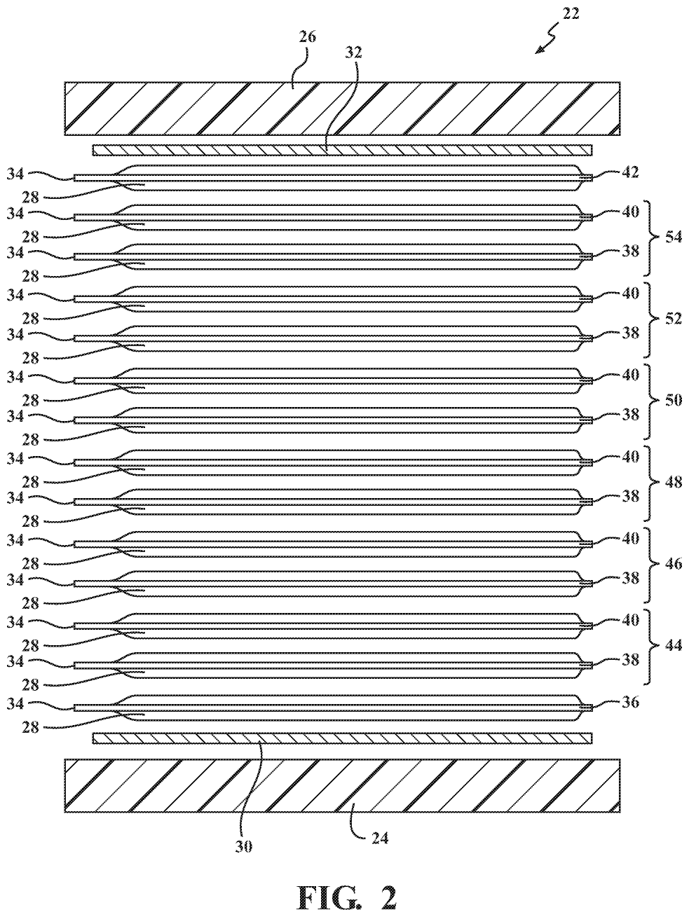

Referring to the Figures, wherein like numerals indicate like parts throughout the several views, an assembly line 20 is depicted schematically in FIG. 1. The assembly line 20 may be used to assemble a battery cell stack 22, a non-limiting exemplary embodiment of which is generally shown in FIG. 2. The present teachings may be applied to configure the assembly line 20 differently than is illustrated in FIG. 1 and described herein for the purpose of assembling a variation of the battery cell stack 22 that may be configured differently than the exemplary embodiment of FIG. 2. However, for illustrated consistency the assembly line 20 will be described hereinafter as employed in the assembly of the battery cell stack 22.

The battery cell stack 22 of FIG. 2 includes respective first and second end plates 24 and 26 disposed at axial ends of the battery cell stack 22. A plurality of battery cells 28 are disposed between the first and second end plates 24 and 26. A first isolation layer 30 may be disposed between the first end plate 24 and the most proximate of the battery cells 28. Similarly, a second isolation layer 32 may be disposed between the second end plate 26 and the battery cells 28 disposed in proximity to the second end plate 26. Although connections are omitted for illustrative clarity, and simplicity, those of ordinary skill in the art will appreciate that the battery cells 28 are electrically connected to each other, e.g., using series and/or parallel connections, in order to provide a desired voltage, current, and/or power density. Those of ordinary skill in the art will also appreciate the general electrochemical operating function and structure of the first end plate 24, the second end plate 26, and the various battery cells 28, with the simplified depiction of FIG. 2 serving to establish a general type of battery cell stack 22 that may be assembled via the present teachings.

In order to provide the desired electrical connections, each of the battery cells 28 may be configured slightly differently from each other throughout the battery cell stack 22. For example, some of the battery cells 28 may have a different orientation relative to the battery cell stack 22 than others, while other battery cells 28 may have a different length and/or bend in a given electrical terminal 34 relative to the other battery cells 28, etc. In the exemplary embodiment of the battery cell stack 22 shown in FIG. 2, the battery cells 28 may include a nominal first configuration 36, a second configuration 38, a third configuration 40, and a fourth configuration 42. While shown with a similar appearance in the schematic view of FIG. 2, for the purposes of the disclose the differences noted above may include any or all of the noted different orientation, length, and/or bend or other features.

The battery cells 28 of the battery cell stack 22 are also arranged in a specific order. The total number and order of the battery cells 28 will vary between different embodiments of battery cell stacks 22. The battery cell stack 22 includes a plurality of cell groups 44, 46, 48, 50, 52, and 54, with each of the cell groups 44, 46, 48, 50, 52, and 54 collectively having a plurality of the battery cells 28 arranged in a defined sequence. In addition to the battery cells 28 of the cell groups 44, 46, 48, 50, 52, and 54, the battery cell stack 22 may additionally include, but is not required to include, other battery cells 28 that are not included in the illustrated cell groups 44, 46, 48, 50, 52, and 54.

For example, referring to the exemplary embodiment of the battery cell stack 22 shown in FIG. 2, fourteen (14) battery cells 28 of four different configurations may be used, i.e., the first configuration 36, the second configuration 38, the third configuration 40, and the fourth configuration 42. The battery cell stack 22 may optionally include six (6) cell groups 44, 46, 48, 50, 52, and 54, i.e., a first cell group 44, a second cell group 46, a third cell group 48, a fourth cell group 50, a fifth cell group 52, and a sixth cell group 54. Each of the cell groups 44, 46, 48, 50, 52, and 54 in such an embodiment may include one battery cell 28 of the second configuration 38 and one battery cell 28 of the third configuration 40, positioned in such an order from bottom to top in FIG. 2. One battery cell 28 of the first configuration 36 may be positioned immediately adjacent to the first end plate 24 in the battery cell stack 22. One battery cell 28 of the fourth configuration 42 may be positioned immediately adjacent to the second end plate 26 in the battery cell stack 22. The cell groups 44, 46, 48, 50, 52, and 54 may be positioned between the one battery cell 28 of the first configuration 36 and the one battery cell 28 of the fourth configuration 42. Each of the cell groups 44, 46, 48, 50, 52, and 54 may be replicated in the same order a multiple number of times throughout the battery cell stack 22. It should also be appreciated that the particular embodiment of the battery cell stack 22 shown and described herein is merely one exemplary embodiment, and that the battery cell stack 22 may be configured differently than the exemplary battery cell stack 22 shown and described herein. For example, other embodiments of the battery cell stack 22 may include a different total number of battery cells 28, may include a different number of configurations of the battery cells 28, may include a different number of cell groups, and that the cell groups may include a different number and combination of battery cells 28.

The battery cell stack 22 may be assembled by stacking the individual components of the battery cell stack 22 one on top of another. For the exemplary embodiment described herein and shown in FIG. 2, the first end plate 24 begins the battery cell stack 22, with the battery cells 28 stacked on top of the first end plate 24 one at a time in the specific order shown in FIG. 2. More specifically, one battery cell 28 of the first configuration 36, along with the first isolation layer 30, is placed on top of the first end plate 24, after which one battery cell 28 of the second configuration 38 is placed on top of the battery cell 28 of the first configuration 36. One battery cell 28 of the third configuration 40 is then placed on top of the battery cell 28 of the second configuration 38 to complete the first cell group 44. The process is continued until the entire battery cell stack 22 is assembled in the order shown in FIG. 2.

Referring again to FIG. 1, the assembly line 20 may include a transport system 56 that includes a number of stack locations 58, 60, 62, 64, 66, 68, and 70 and a conveyor 72 operable to move the number of stack locations 58, 60, 62, 64, 66, 68, and 70 in a closed loop 74, with the stack locations of FIG. 1 respectively referred to herein as first, second, third, fourth, fifth, sixth, and seventh stack locations 58, 60, 62, 64, 66, 68, and 70 for clarity. The specific shape of the closed loop 74 may vary. For example, the closed loop 74 may be circular or oval. Other embodiments may include the closed loop 74 being configured in a more complex shape.

The conveyor 72 may include any mechanism that is capable of moving the stack locations 58, 60, 62, 64, 66, 68, and 70 in the closed loop 74. For example, the conveyor 72 may include a rotatable table, a conveyor belt, or some other similar mechanism, as will be appreciated by those of ordinary skill in the art. The plurality of stack locations 58, 60, 62, 64, 66, 68, and 70 are arranged on the conveyor 72 and provide a specific location at which to assembly the battery cell stack 22. The stack locations 58, 60, 62, 64, 66, 68, and 70 may include a tray or other device to help precisely position the components of the battery cell stack 22 relative to each other as they are positioned.

A plurality of cell handling stations 76, 80, 86, 92, 94, 102, and 104 is disposed around the transport system 56. The number of the stack locations 58, 60, 62, 64, 66, 68, and 70 is equal to a total number of the cell handling stations 76, 80, 86, 92, 94, 102, and 104, e.g., the assembly line 20 may include seven (7) cell handling stations 76, 80, 86, 92, 94, 102, and 104 and the seven (7) stack locations 58, 60, 62, 64, 66, 68, and 70. The conveyor 72 is operable to move each of the stack locations 58, 60, 62, 64, 66, 68, and 70 past each of the plurality of cell handling stations 76, 80, 86, 92, 94, 102, and 104 once during a single transport cycle of the closed loop 74. One transport cycle is defined as one complete cycle through the closed loop 74 of the conveyor 72. As noted previously, the assembly line 20 may be configured differently than the exemplary embodiment shown in FIG. 1, for assembling a battery cell stack 22 that is configured differently than the exemplary embodiment shown in FIG. 2. In such a case, the number of cell handling stations and the corresponding number of stack locations will vary from the exemplary embodiment described herein.

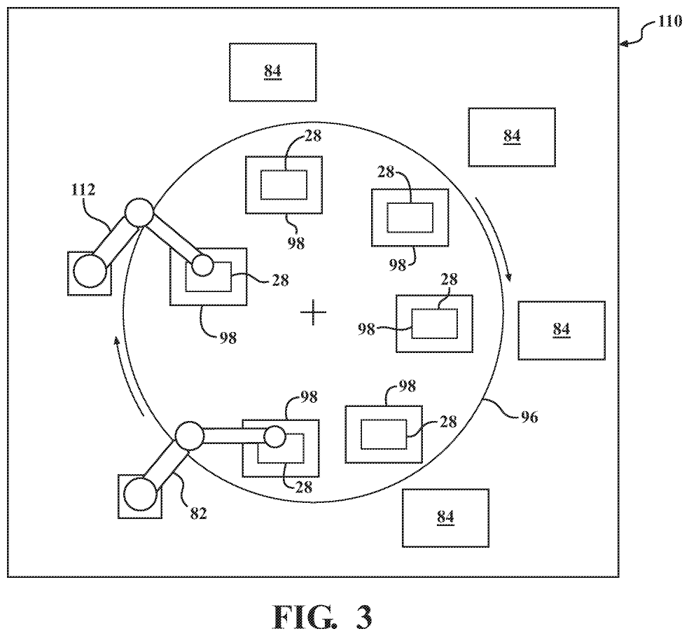

One of the plurality of cell handling stations includes the stack unloading station 76, which in turn includes a pick-and-place machine 78. The pick and place machine 78 may include any machine capable of removing a completed battery cell stack 22 from the stack locations 58, 60, 62, 64, 66, 68, and 70 on the transport system 56, and placing the removed battery cell stack 22 on another line, cart, etc., for further operations. The plurality of cell handling stations 76, 80, 86, 92, 94, 102, and 104 may further include a number of group preparation stations, e.g., cell handling stations 92 and 94, and a number of non-group handling stations, e.g., cell handling stations 80, 86, 102, and 104. One of the non-group handling stations, such as station 80, may be configured as a first end plate positioning station having a placement machine 82 operable for placing the first end plate 24 of FIG. 1 on the stack locations 58, 60, 62, 64, 66, 68, and 70 of the conveyor 72 to begin assembly of each of the battery cell stacks 22. The cell handling stations 80, when configured as such a first end plate positioning station, may include one or more preparation machines 84 (generally shown in FIG. 3) for performing all required preparatory tasks necessary to prepare the first end plate 24 of FIG. 1 for placement. For example, station 80 configured as such a first end plate positioning station may include a layering machine for placing the first isolation layer 30 of FIG. 1 onto the first end plate 24.

Another of the non-group handling stations may include a second end plate positioning station having a placement machine 82 operable for placing the second end plate 26 on the stack locations 58, 60, 62, 64, 66, 68, and 70 of the conveyor 72 in order to complete each of the battery cell stacks 22. Station 86 when configured as such a second end plate positioning station may include one or more preparation machines 84 (FIG. 3) for performing all required preparatory tasks necessary to prepare the second end plate 26 for placement.

Station 86 when configured as the second end plate positioning station immediately precedes station 76, configured as a stack unloading station in the transport cycle of closed loop 74 shown in FIG. 2. As shown in FIG. 1, the transport cycle follows a path indicated by dashed line 88 in a counter-clockwise direction as indicated by arrow 90. The stack unloading station 76 immediately precedes the first end plate positioning station 80 in the transport cycle of the closed loop 74. Accordingly, station 80 configured as the first end plate positioning station is the first cell handling station after the stack unloading station, i.e., station 76. As such, when station 76 removes a completed battery cell stack 22 from a respective stack location, that respective stack location is traversed along the closed loop 74 to station 80, i.e., the first end plate positioning station, so that station 80 may be used to position the first end plate 24 of FIG. 1 on that respective stack location to begin a new battery cell stack 22. Station 86 precedes to station 76 for stack unloading, and positions the second end plate 26 on the battery cell stack 22 to complete assembly of the battery cell stack 22. After the second end plate 26 is positioned on the battery cell stack 22 in a respective stack location, that respective stack location is traversed along the closed loop 74 to station 76 for stack unloading so that the pick-and-place machine 78 of station 76 may remove the completed battery cell stack 22 from that respective stack location.

As noted above, the plurality of cell handling stations 76, 80, 86, 92, 94, 102, and 104 includes the number of group preparation stations, e.g., stations 92 and 94. The number of group preparation stations 92 and 94 is equal to a total number of battery cells 28 within each cell group. In the exemplary embodiment of the battery cell stack 22 shown in FIG. 2, each of the cell groups 44, 46, 48, 50, 52, and 54 is defined as including one battery cell 28 of the second configuration 38 and one battery cell 28 of the third configuration 40. According, the total number of group preparation stations 92 and 94 is equal to two (2), i.e., a first group preparation station 92 for the battery cells 28 of the second configuration 38, and a second group preparation station 94 for the battery cells 28 of the third configuration 40. Since the cell groups 44, 46, 48, 50, 52, and 54 in the exemplary embodiment are defined to include a total of two battery cells 28, the total number of group preparation stations 92 and 94 is also equal to two (2). However, if the cell groups were defined to include a different total number of battery cells 28, for example four battery cells 28, then the total number of group preparation stations would be equal to four (4). As such, the total number of battery cells 28 used within each cell group determines the total number of group preparation stations. By changing the pre-defined sequence of battery cells 28 within each cell group, the total number of battery cells 28 within each cell group may also be changed, the total number of cell groups may change, and the total number of group preparation stations may also be changed.

Each respective group preparation station 92 and 94 is dedicated to preparing one respective battery cell 28 within the defined sequence of battery cells 28 for each cell group. As such, the first group preparation station 92 prepares and places the second configuration 38 of the battery cells 28 on the conveyor 72, whereas the second group preparation station 94 prepares and places the third configuration 40 of the battery cells 28 on the conveyor 72. The first group preparation station 92 is positioned prior to the second group preparation station 94 in the in the transport cycle of the close loop.

Referring to FIG. 3, a generic cell handling station 110 is representative of the non-group cell handling stations 80, 86, 102, and 104 and the group preparation stations 92 and 94 of FIG. 1. The representative cell handling station 110 includes a transport device 96, e.g., a turn table or other suitable device. The transport device 96 provides a plurality of preparation locations 98 disposed about the transport device 96. At least one of the preparation locations 98 has an associated preparation machine 84 for performing one task the battery cells 28. Each cell handling station 110 includes all of the preparation machines 84 required to perform all required tasks for a respective battery cell 28 within the defined sequence of battery cells 28. Because each configuration of the battery cells 28 may require different tasks be performed, each of the different cell handling stations may include a different combination of the preparation machines 84. For example, the first group preparation station 92 may include all of the preparation machines 84 necessary to perform all preparatory tasks on its respective battery cells 28 to configure those battery cells 28 in the second configuration 38, whereas the second group reparation station 94 includes all of the preparation machines 84 necessary to perform all preparatory tasks on its respective battery cells 28 to configure those battery cells 28 in the third configuration 40.

The preparation machines 84 of FIG. 3 may include, but are not limited to, at least one of a flipping machine for flipping a battery cell 28, a rotating machine for rotating the battery cell 28, a cutting machine for cutting at least one electrical terminal 34 of the battery cell 28 (see FIG. 2), a bending machine for bending at least one electrical terminal 34 of the battery cell 28, a layering machine for placing an isolation layer on the battery cell 28, and a pick-and-place machine 78 for grasping the battery cell 28 from the transport device 96 and placing the battery cell 28 on the stack locations 58, 60, 62, 64, 66, 68, and 70 of the transport system 56.

A loading machine 112 may be used to place one unprepared battery cell on each preparation location 98 as the transport device 96 moves the preparation locations 98 past the loading machine 112. The loading machine 112 may include any mechanism capable of placing a battery cell 28 on the preparation location 98 of the transport device 96. The transport device 96 moves each respective battery cell 28 past each respective preparation machine 84. Each preparation machine 84 in turn performs one specific task on the battery cell 28, after which the transport device 96 moves the battery cell 28 to the next preparation machine 84 for the next task. Once all preparatory tasks are complete on the battery cell 28, the placement machine 82 removes the battery cell 28 from the transport device 96, and places the prepared battery cell 28 on one of the stack locations 58, 60, 62, 64, 66, 68, and 70 of the conveyor 72.

As noted above, the non-group handling stations includes station 80, i.e., the first end plate positioning station, and station 86 configured as the second end plate positioning station. In some embodiments of the battery cell stack 22, which include battery cells 28 that are not included in the cell groups 44, 46, 48, 50, 52, and 54, the non-group handling stations may further include one or more non-group preparation stations 102, 104. The non-group preparation stations of FIG. 1 therefore include station 102, i.e., a first non-group preparation station for preparing and placing battery cells 28 of the first configuration 36 on the conveyor 72, and station 104 as a second non-group preparation station for preparing and placing the battery cells 28 of the fourth configuration 42 on the conveyor 72.

Because one battery cell 28 of the first configuration 36 is positioned in sequence prior to any of the cell groups 44, 46, 48, 50, 52, and 54, station 102 (first non-group preparation station) is positioned after station 80 (the first end plate positioning station), and prior to the first group preparation station 92 in the transport cycle of the closed loop 74. In contrast, because one battery cell 28 of the fourth configuration 42 is positioned in sequence after all of the cell groups 44, 46, 48, 50, 52, and 54 have been assembled in the battery cell stack 22, the second non-group preparation station 104 is positioned after the last of the group preparations stations, i.e., the second group preparation station 94, and immediately preceding the second end plate positioning station 86, in the transport cycle of the closed loop 74.

Each respective non-group preparation station 102 and 104 is dedicated to preparing one respective battery cell 28 within the battery cell stack 22 that is not included in one of the plurality of cell groups 44, 46, 48, 50, 52, and 54. The non-group preparation stations, i.e., stations 102 and 104, are configured and operate in the same manner as the group preparation stations 92 and 94 described above with reference to FIG. 3. As such, each of the non-group preparation stations 102 and 104 include their respective transport device 96 providing the preparation locations 98, and the required preparation machines 84 for performing all of the required preparatory tasks for their respective battery cells 28.

The assembly line 20 described above may be used to implement a method of assembling the battery cell stack 22. The method includes defining the sequence of battery cells 28 within each cell group. As noted above, the sequence of battery cells 28 within each cell group in the exemplary embodiment described herein includes one battery cell 28 of the second configuration 38 followed by one battery cell 28 of the third configuration 40. This sequence of battery cells 28 for each cell group requires two group preparation stations 92, 94, one to prepare the battery cells 28 of the second configuration 38, and one to prepare the battery cells 28 of the third configuration 40. The sequence is defined in a manner such that all battery cells 28 in the sequence are replicated in the same order for each of the cell groups 44, 46, 48, 50, 52, and 54. It should be appreciated that each configuration of the battery cell stack 22 may be formed using different assembly sequences, but that the different assembly sequences will change the total number of battery cells 28 within each cell group, and the total number of cell groups 44, 46, 48, 50, 52, 54. Furthermore, as noted above, defining the sequence to include a greater number of battery cells 28 within each cell group requires a greater number of group preparation stations 92, 94, because each battery cell 28 in the sequence of battery cells 28 of a cell group requires its own respective group preparation station. Accordingly, the sequence of battery cells 28 within each cell group must be defined before the assembly line 20 may be arranged.

Once the sequence of battery cells 28 within each cell group is defined, the assembly line 20 may be provided. As described above, the assembly line 20 is provided to include the plurality of cell handling stations 76, 80, 86, 92, 94, 102, 104 disposed around the transport system 56, with the transport system 56 having the number of stack locations 58, 60, 62, 64, 66, 68, 70 equal to the total number of the cell handling stations 76, 80, 86, 92, 94, 102, 104. The cell handling stations 76, 80, 86, 92, 94, 102, 104 include the stack unloading station 76, the non-group handling stations 80, 86, 102, 104, and the group preparation stations 92, 94 as described above. The specific number and configuration of each is dependent upon the specific order of the battery cells 28 in the battery cell stack 22, and the pre-defined sequence of battery cells 28 within each of the cell groups 44, 46, 48, 50, 52, 54. As noted above, the transport system 56 is operable to move each of the stack locations 58, 60, 62, 64, 66, 68, 70 past each of the cell handling stations 76, 80, 86, 92, 94, 102, 104 once during a transport cycle.

The assembly of a single battery cell stack 22 on the first stack location 58 is described below. While only a single battery cell stack 22 is described in detail, the general assembly of a subsequent battery cell stack 22 on the second stack location 60 directly following the first stack location 58 is generally noted for a first transport cycle. It should be appreciated that as the transport system 56 is moved between the different cell handling stations 76, 80, 86, 92, 94, 102, 104, the steps described relative to the assembly of the battery cell stack 22 on the first stack location 58 are repeated for the following stack locations 58, 60, 62, 64, 66, 68, 70 as they are positioned adjacent each respective cell handling station. Similarly, the steps described relative to the assembly of the battery cell stack 22 on the first stack location 58 on the subsequent transport cycles are repeated for the following stack locations 58, 60, 62, 64, 66, 68, 70.

Referring once again to FIG. 1, assembly of the battery cell stack 22 begins with the first stack location 58 empty, and positioned adjacent the stack unloading station 76, and the second stack location 60 disposed at the second end plate positioning station 86, and including a completed battery cell stack 22. The conveyor 72 system is then moved to position the first stack location 58 adjacent the first end plate positioning station 80. This movement simultaneously moves the second stack location 60 adjacent to the stack unloading station 76 so that the stack unloading station 76 may remove the completed battery cell stack 22 at the second stack location 60 from the transport system 56.

With the first stack location 58 disposed at the first end plate positioning station 80, the first end plate positioning station 80 places the first end plate 24 on the transport system 56 at the first stack location 58. Optionally, the first end plate positioning station 80 may include a layering machine for placing the first isolation layer 30 on the first end plate 24, prior to placing the first end plate 24 on the stack location of the conveyor 72. It should be appreciated that other tasks may be performed on the first end plate 24 prior to the placement machine 82 of the first end plate positioning station 80 placing the first end plate 24 on the first stack location 58 of the conveyor 72.

Once the first end plate 24 has been placed on the first stack location 58, the transport system 56 is moved to position the first stack location 58 adjacent the first non-group preparation station 102. This movement simultaneously positions the second stack location 60 adjacent the first end plate positioning station 80 so that the first end plate positioning station 80 may position a first end plate 24 on the conveyor 72 at the second stack location 60.

The first non-group preparation station 102 prepares and places a battery cell 28 of the first configuration 36 on top of the first end plate 24. The first non-group preparation station 102 may perform at least one task on its respective battery cells 28 to configure them in the first configuration 36. The tasks may include, but are not limited to, flipping the battery cell 28, rotating the battery cell 28, trimming one of the electrical terminals 34 of the battery cell 28, bending one of the electrical terminals 34 of the battery cell 28, etc. If the first isolation layer 30 was not placed with the first end plate 24, then the first isolation layer 30 may be placed with the battery cell 28 of the first configuration 36 by the first non-group preparation station 102. As described above, the first non-group preparation station 102 performs all preparatory tasks necessary to configure a battery cell 28 into the first configuration 36, and place it on the conveyor 72 system.

Once the battery cell 28 of the first configuration 36 has been placed on the first end plate 24 on the first stack location 58, the transport system 56 is moved to position the first stack location 58 adjacent the first group preparation station 92. This movement simultaneously positions the second stack location 60 adjacent the first non-group preparation station 102 so that the first non-group preparation station 102 may position a battery cell 28 of the first configuration 36 on the conveyor 72 at the second stack location 60.

The first group preparation station 92 prepares and places a battery cell 28 of the second configuration 38 on top of the battery cell 28 of the first configuration 36. As described above, the first group preparation station 92 performs all preparatory tasks necessary to configure a battery cell 28 into the second configuration 38, and place it on the conveyor 72. The first group preparation station 92 may perform at least one task on its respective battery cells 28 to configure them in the second configuration 38. The tasks may include, but are not limited to, flipping the battery cell 28, rotating the battery cell 28, trimming one of the electrical terminals 34 of the battery cell 28, bending one of the electrical terminals 34 of the battery cell 28, etc.

Once the battery cell 28 of the second configuration 38 has been placed on the battery cell 28 of the first configuration 36, the transport system 56 is moved to position the first stack location 58 adjacent the second group preparation station 94. This movement simultaneously positions the second stack location 60 adjacent the first group preparation station 92 so that the first group preparation station 92 may position a battery cell 28 of the second configuration 38 on the conveyor 72 at the second stack location 60.

The second group preparation station 94 prepares and places a battery cell 28 of the third configuration 40 on top of the battery cell 28 of the second configuration 38, thereby completing one cell group, i.e., the first cell group 44. As described above, each cell group in this exemplary embodiment is defined to include one battery cell 28 of the second configuration 38 and one battery cell 28 of the third configuration 40. The second group preparation station 94 performs all preparatory tasks necessary to configure a battery cell 28 into the third configuration 40, and place it on the conveyor 72. The second group preparation station 94 may perform at least one task on its respective battery cells 28 to configure them in the third configuration 40. The tasks may include, but are not limited to, flipping the battery cell 28, rotating the battery cell 28, trimming one of the electrical terminals 34 of the battery cell 28, bending one of the electrical terminals 34 of the battery cell 28, etc.

Once the battery cell 28 of the third configuration 40 has been placed on the battery cell 28 of the second configuration 38 to complete the first cell group 44, the transport system 56 is moved to position the first stack location 58 adjacent the second non-group preparation station 104. This movement simultaneously positions the second stack location 60 adjacent the second group preparation station 94 so that the second group preparation station 94 may position a battery cell 28 of the third configuration 40 on the conveyor 72 at the second stack location 60.

As described above, the second non-group preparation station 104 prepares and places battery cells 28 of the fourth configuration 42, but only when all of the cell groups 44, 46, 48, 50, 52, 54 have been placed on the battery cell stack 22. At this point in the description of the assembly of the battery cell stack 22, only one of the first cell group 44 of the six cell groups 44, 46, 48, 50, 52, 54 have been placed on the battery cell stack 22. Therefore, the second non-group preparation station 104 does not position a battery cell 28 on the first stack location 58 at this time.

The transport system 56 is then moved to position the first stack location 58 adjacent the second end plate positioning station 86. This movement simultaneously positions the second stack location 60 adjacent the second non-group preparation station 104. As described above, the second end plate positioning station 86 prepares and places the second end plate 26, but only when all of battery cells 28 of the battery cell stack 22 have been positioned in order. At this point in the description of the assembly of the battery cell stack 22, all of the battery cells 28 of the battery cell stack 22 have not yet been positioned. Therefore, the second end plate positioning station 86 does not position the second end plate 26 on the first stack location 58 at this time.

The transport system 56 is then moved to position the first stack location 58 adjacent the stack unloading station 76. This movement simultaneously positions the second stack location 60 adjacent the second end plate positioning station 86. As described above, the stack unloading station 76 removes the completed battery cell stack 22 from the transport system 56. However, at this point in the description of the assembly of the battery cell stack 22, assembly of the battery cell stack 22 is not yet complete. Therefore, the stack unloading station 76 does not remove the partially completed battery cell stack 22 from the conveyor 72 system. This completes one transport cycle of the closed loop 74 of the transport system 56. As noted above, each transport cycle forms one of the cell groups 44, 46, 48, 50, 52, 54. The transport system 56 is moved through a pre-defined number of transport cycles. The pre-defined number of transport cycles is equal to the total number of the cell groups 44, 46, 48, 50, 52, 54. Since the exemplary embodiment of the battery cell stack 22 is defined to include six cell groups 44, 46, 48, 50, 52, 54, the transport system 56 is moved through the closed loop 74 a total of six transport cycles. At this point in the description of the assembly of the battery cell stack 22, the transport system 56 has completed one transport cycle. Accordingly, the transport system 56 is cycled to complete five additional transport cycles. The description of the second transport cycle is described below.

To begin the second transport cycle of the process, the first stack location 58 is moved from the stack unloading station 76 to the first end plate positioning station 80. Because the first end plate positioning station 80 only positions the first end plate 24 to begin assembly of a new battery cell stack 22, and the current battery cell stack 22 on the first stack location 58 is partially complete, the first end plate 24 positioning system does not place a first end plate 24 on the first stack location 58.

The first stack location 58 is then moved from the first end plate positioning station 80 to the first non-group preparation station 102. Because the first non-group preparation station 102 only positions battery cells 28 of the first configuration 36 adjacent the first end plate 24, and because the current battery cell stack 22 on the first stack location 58 is partially complete, the first non-group preparation station 102 does not position a battery cell 28 of the first configuration 36 on the partially completed battery cell stack 22 on the first stack location 58.

The first stack location 58 is then moved from the first non-group preparation station 102 to the first group preparation station 92, the first group preparation station 92 prepares and places a battery cell 28 of the second configuration 38 on top of the battery cell 28 of the third configuration 40, i.e., the last battery cell 28 placed in the first cell group 44.

Once the battery cell 28 of the second configuration 38 has been placed on the battery cell 28 of the third configuration 40, the transport system 56 is moved to position the first stack location 58 adjacent the second group preparation station 94. The second group preparation station 94 prepares and places a battery cell 28 of the third configuration 40 on top of the battery cell 28 of the second configuration 38, thereby completing the second cell group 46.

Once the battery cell 28 of the third configuration 40 has been placed on the battery cell 28 of the second configuration 38 to complete the second cell group 46, the transport system 56 is moved to position the first stack location 58 adjacent the second non-group preparation station 104.

As described above, the second non-group preparation station 104 prepares and places battery cells 28 of the fourth configuration 42, but only when all six of the cell groups 44, 46, 48, 50, 52, 54 have been placed on the battery cell stack 22. At this point in the description of the assembly of the battery cell stack 22, only two of the six cell groups 44, 46, 48, 50, 52, 54 have been placed on the battery cell stack 22. Therefore, the second non-group preparation station 104 does not position a battery cell 28 on the first stack location 58 at this time.

The transport system 56 is then moved to position the first stack location 58 adjacent the second end plate positioning station 86. As described above, the second end plate positioning station 86 prepares and places the second end plate 26, but only when all of battery cells 28 of the battery cell stack 22 have been positioned in order. At this point in the description of the assembly of the battery cell stack 22, all of the battery cells 28 of the battery cell stack 22 have not yet been positioned. Therefore, the second end plate positioning station 86 does not position the second end plate 26 on the first stack location 58 at this time.

The transport system 56 is then moved to position the first stack location 58 adjacent the stack unloading station 76. As described above, the stack unloading station 76 removes the completed battery stack from the transport system 56. However, at this point in the description of the assembly of the battery cell stack 22, assembly of the battery cell stack 22 is not yet complete. Therefore, the stack unloading station 76 does not remove the partially completed battery cell stack 22 from the conveyor 72 system. This completes a second transport cycle of the closed loop 74 of the transport system 56.

The above process for the second transport cycle is repeated three additional transport cycles to complete the third cell group 48, the fourth cell group 50, and the fifth cell group 52 respectively, after which the battery cell stack 22 has five of the six cell groups 44, 46, 48, 50, 52, 54 formed, and has completed five of the six transport cycles. The sixth and final transport cycle to complete the battery cell stack 22 is described below.

To begin the sixth transport cycle of the process, the first stack location 58 is moved from the stack unloading position to the first end plate positioning station 80. Because the first end plate positioning station 80 only positions the first end plate 24 to begin assembly of a new battery cell stack 22, and the current battery cell stack 22 on the first stack location 58 is partially complete, the first end plate 24 positioning system does not place a first end plate 24 on the first stack location 58.

The first stack location 58 is then moved from the first end plate positioning station 80 to the first non-group preparation station 102. Because the first non-group preparation station 102 only positions battery cells 28 of the first configuration 36 adjacent the first end plate 24, and because the current battery cell stack 22 on the first stack location 58 is partially complete, the first non-group preparation station 102 does not position a battery cell 28 of the first configuration 36 on the partially completed battery cell stack 22 on first stack location 58.

The first stack location 58 is then moved from the first non-group preparation station 102 to the first group preparation station 92, the first group preparation station 92 prepares and places a battery cell 28 of the second configuration 38 on top of the battery cell 28 of the third configuration 40, i.e., the last battery cell 28 placed in the fifth cell group 52.

Once the battery cell 28 of the second configuration 38 has been placed on the battery cell 28 of the third configuration 40, the transport system 56 is moved to position the first stack location 58 adjacent the second group preparation station 94. The second group preparation station 94 prepares and places a battery cell 28 of the third configuration 40 on top of the battery cell 28 of the second configuration 38, thereby completing the sixth cell group 54.

Once the battery cell 28 of the third configuration 40 has been placed on the battery cell 28 of the second configuration 38 to complete the sixth cell group 54, the transport system 56 is moved to position the first stack location 58 adjacent the second non-group preparation station 104. The second non-group preparation station 104 prepares and places a battery cell 28 of the fourth configuration 42 on top of the last battery cell 28 of the sixth cell group 54. The second non-group preparation station 104 may perform at least one task on its respective battery cells 28 to configure them in the fourth configuration 42. The tasks may include, but are not limited to, flipping the battery cell 28, rotating the battery cell 28, trimming one of the electrical terminals 34 of the battery cell 28, bending one of the electrical terminals 34 of the battery cell 28, etc. The second isolation layer 32 may be placed on the battery cell stack 22 with the battery cell 28 of the fourth configuration 42. As described above, the second non-group preparation station 104 performs all preparatory tasks necessary to configure a battery cell 28 into the fourth configuration 42, and place it on the conveyor 72 system.

Once the battery cell 28 of the fourth configuration 42 has been placed on the battery cell stack 22, the transport system 56 is moved to position the first stack location 58 adjacent to the second end plate positioning station 86.

With the first stack location 58 disposed at the second end plate positioning station 86, the second end plate positioning station 86 places the second end plate 26 on the transport system 56 at the first stack location 58. Optionally, if the second isolation layer 32 was not placed with the battery cell 28 of the fourth configuration 42, the second end plate positioning station 86 may include a layering machine for placing the second isolation layer 32 on the second end plate 26, prior to placing the second end plate 26 on the battery cell stack 22. It should be appreciated that other tasks may be performed on the second end plate 26 prior to the pick and place machine 78 of the second end plate positioning station 86 placing the second end plate 26 on the battery cell stack 22.

Once the second end plate 26 has been placed on the battery cell stack 22 on the first stack location 58, that battery cell stack 22 is complete. The transport system 56 is moved to position the first stack location 58 adjacent the stack unloading station 76, so that the stack unloading station 76 may pick up and remove the completed battery cell stack 22 from the conveyor 72 system, after which, the process begins again.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A method of assembling a battery cell stack having a plurality of cell groups, with each of the plurality of cell groups having a plurality of battery cells arranged in a defined sequence, the method comprising:
providing a plurality of cell handling stations disposed around a transport system having a number of stack locations, wherein the transport system is configured to move each of the stack locations past each of the plurality of cell handling stations once during a transport cycle, and the plurality of cell handling stations includes a number of group preparation stations;
positioning one of the plurality of battery cells of one of the plurality of cell groups on each respective one of the stack locations with each respective group preparation station during each transport cycle of the transport system; and
moving the transport system through a pre-defined number of transport cycles.

2. The method set forth in claim 1, wherein the plurality of cell handling stations includes a number of non-group handling stations, and wherein the method further comprises positioning a battery component on each respective one of the stack locations with each respective non-group handling station during one of the pre-defined number of transport cycles of the transport system, wherein the battery component includes a non-group battery cell, a first end plate, or a second end plate.

3. The method set forth in claim 2, wherein each of the non-group handling stations do not position a battery component at any of the stack locations during at least one of the pre-defined number of transport cycles.

4. The method set forth in claim 2, wherein one of the non-group handling stations includes a first end plate positioning station operable to place the first end plate at each stack location prior to placement of any battery cells of the battery cell stack to begin assembly of the battery cell stack.

5. The method set forth in claim 2, wherein one of the non-group handling stations includes a second end plate positioning station operable to place the second end plate at each stack location after placement of all of the battery cells of the battery cell stack to complete assembly of the battery cell stack.

6. The method set forth in claim 1, wherein the number of group preparation stations is equal to a total number of battery cells within each cell group, and wherein each respective group preparation station is dedicated to preparing one respective battery cell within the defined sequence of battery cells for each cell group.

7. The method set forth in claim 6, further comprising preparing a respective one of the plurality of battery cells within the defined sequence of battery cells, with the respective one of the group preparation stations dedicated thereto, for each transport cycle.

8. The method set forth in claim 7, wherein preparing the respective one of the plurality of battery cells within the defined sequence of battery cells, with the respective one of the group preparation stations dedicated thereto, includes performing at least one task on the respective battery cell.

9. The method set forth in claim 8, wherein the at least one task includes one of flipping the battery cell, rotating the battery cell, cutting at least one terminal of the battery cell, bending at least one terminal of the battery cell, placing an isolation layer on the battery cell, and positioning the battery cell on the transport system at one of the stack locations.

10. The method set forth in claim 1, wherein the number of group preparation stations is equal to the total number of battery cells within each respective cell group, such that each of the group preparation stations positions a respective battery cell at each stack location during each transport cycle.

11. The method set forth in claim 1, wherein one of the plurality of cell handling stations includes a stack unloading station operable to remove a completed battery cell stack from the transport system.

12. An assembly line for assembling a battery cell stack having a plurality of cell groups, with each of the cell groups having a plurality of battery cells arranged in a defined sequence, the assembly line comprising:
a transport system having a number of stack locations and a conveyor operable to move the number of stack locations in a closed loop;
a plurality of cell handling stations disposed around the transport system;
wherein the number of stack locations is equal to a total number of the plurality of cell handling stations;
wherein the conveyor is operable to move each of the stack locations past each of the plurality of cell handling stations once during a transport cycle of the closed loop;
wherein the plurality of cell handling stations includes a number of group preparation stations, with the number of group preparation stations equal to a total number of battery cells within each cell group; and
wherein each respective group preparation station is dedicated to preparing one respective battery cell within the defined sequence of battery cells for each cell group.

13. The assembly line set forth in claim 12, wherein one of the plurality of cell handling stations includes a stack unloading station having a pick and place machine operable to remove a completed battery cell stack from the transport system.

14. The assembly line set forth in claim 13, wherein the plurality of cell handling stations includes a number of non-group handling stations, with one of the plurality of non-group handling stations including a first end plate positioning station having a placement machine operable to place a first end plate on the stack locations of the conveyor.

15. The assembly line set forth in claim 14, wherein one of the plurality of non-group handling stations includes a second end plate positioning station having a placement machine operable to place a second end plate on the stack locations of the conveyor.

16. The assembly line set forth in claim 15, wherein the second end plate positioning station immediately precedes the stack unloading station in the transport cycle of the closed loop, and wherein the stack unloading station immediately precedes the first end plate positioning station in the transport cycle of the closed loop.

17. The assembly line set forth in claim 12, wherein each respective group preparation station includes at least one of a flipping machine for flipping the battery cells, a rotating machine for rotating the battery cells, a cutting machine for cutting at least one electrical terminal of the battery cells, a bending machine for bending at least one electrical terminal of the battery cells, a layering machine for placing an isolation layer on the battery cells, and a pick and place machine for grasping and placing the battery cells on the stack locations of the transport system.

18. The assembly line set forth in claim 12, wherein each respective group preparation station includes a transport device providing a plurality of preparation locations disposed about the transport device, with at least one of the preparation locations having a preparation machine for performing one task on a battery cell.

19. The assembly line set forth in claim 18, wherein the preparation machine includes at least one of a flipping machine for flipping the battery cells, a rotating machine for rotating the battery cells, a cutting machine for cutting at least one electrical terminal of the battery cells, a bending machine for bending at least one electrical terminal of the battery cells, a layering machine for placing an isolation layer on the battery cells, and a pick and place machine for grasping the battery cells from the transport device and placing the battery cells on the stack locations of the transport system.

20. The assembly line set forth in claim 19, wherein each respective group preparation station includes a plurality of preparation machines for performing all required tasks for its respective battery cell within the defined sequence of battery cells.

21. The assembly line set forth in claim 14, wherein the number of non-group handling stations includes at least one non-group preparation station, wherein each respective non-group preparation station is dedicated to preparing one respective battery cell within the battery cell stack that is not included in one of the plurality of cell groups.

22. The assembly line set forth in claim 21, wherein each respective non-group preparation station includes a transport device providing a plurality of preparation locations disposed about the transport device, with at least one of the preparation locations having a preparation machine for performing one task on a battery cell.

23. The assembly line set forth in claim 22, wherein each respective non-group preparation station includes a plurality of preparation machines for performing all required tasks for its respective battery cell.
